(19) United States
(12) Patent Application Publication
(10) Pub. No.: US 2008/0134116 A1
(43) Pub. Date: Jun. 5, 2008

(54) METHOD, COMPUTER PROGRAM PRODUCT, AND TOOL FOR TIMING PERFORMANCE OF A HIERARCHICAL CHIP DESIGN HAVING MULTIPLE PARTITION INSTANCES

(75) Inventor: Paul Gregory Curtis, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/565,192

(22) Filed: Nov. 30, 2006

(51) Int. Cl. G06F 17/50

(52) U.S. Cl. 716/6

(57) ABSTRACT

Timing resources are saved in timing performance of a hiearchial chip design having multiple partition instances. A netlist of the chip design is loaded into a timing model, including only one instance of each partition type in the chip design. The timing model is instructed to ignore boundary timing. The timing model is run, analyzing only the internal paths of one instance of each partition type. The top level of the chip design is also loaded into the timing model and left intact. The timing model also takes into account actual voltage and parasitic information from the full chip model. Thus, the performance of the chip design can be timed faster and with fewer resources, as each instance of each partition type does not need to be timed.

### FIELD OF INVENTION

This application relates to timing and, more particularly, to timing performance of a hierarchical chip design.

### BACKGROUND OF INVENTION

Timing the performance of large ASIC chip designs can require long turnaround times and large hardware resources. Turnaround times have become longer and resources needed for timing have increased as more and more detailed timing analysis is being performed. Any reduction in the turnaround time of the timing jobs is very beneficial to the timing closure process.

In hierarchical designs, there may be multiple uses of the same partition, such as a random logic macro (RLM). For a true hierarchical design, each instance of a particular RLM will have substantially identical timing for its internal timing paths. Timing all these identical paths results in a waste of time and resources.

Timing optimization can be performed on a RLM as a standalone run. However, there are drawbacks to this, as all input clock information is estimated, and actual voltage and parasitic information from the full chip model may not be available. In order to achieve the most accurate results, a timing run should be based on timing in a full chip mode.

Accordingly, there is a need for a technique for timing performance of a hierarchical chip design in an accurate an efficient manner.

### SUMMARY OF INVENTION

According to exemplary embodiments, timing resources are saved in timing performance of a hierarchial chip design having multiple partition instances. A netlist of the chip design is loaded into a timing model, including only one instance of each partition type in the chip design. The timing model is instructed to ignore boundary timing. The timing model is run, analyzing only the internal paths of one instance of each partition type. The top level of the chip design is also loaded into the timing model and left intact. The timing model also takes into account actual voltage and parasitic information from the full chip model. Thus, the performance of the chip design can be timed faster and with fewer resources, as each instance of each partition type does not need to be timed.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example of a hierarchical chip design;

FIG. 2 illustrates an exemplary method for timing according to an exemplary embodiment; and

FIG. 3 illustrates an exemplary timing model for a hierarchical chip design according to an exemplary embodiment.

The detailed description explains exemplary embodiments of the invention, together with advantages and features, by way of example with reference to the drawings.

### DETAILED DESCRIPTION OF EMBODIMENTS

According to exemplary embodiments, timing of performance of a chip deign is improved by instructing a timing tool to load only one instance of each partition type into the timing model, when the timing tool is reading in the entire full chip netlist, while leaving the chip top level completely intact. Before starting the timing run, the timing tool is instructed to ignore all boundary timing by not carrying all non-clock inputs to the partitions. Therefore, when the timing is run, only the internal paths of one instance of each partition type is analyzed.

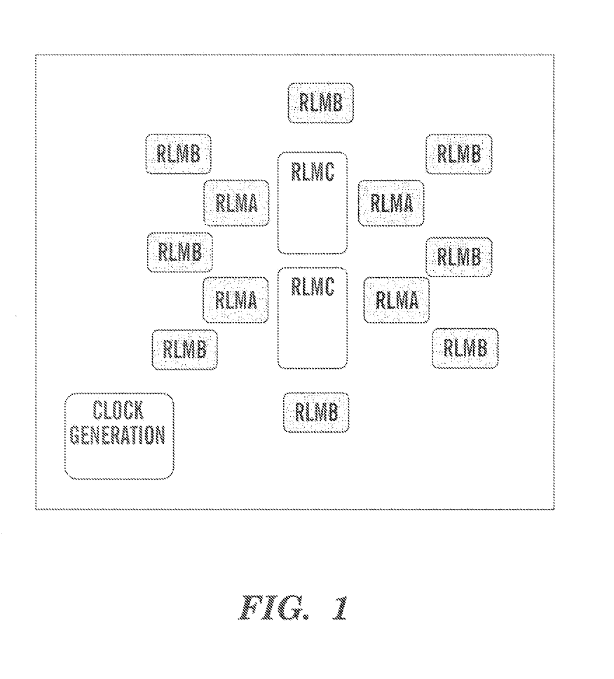

FIG. 1 illustrates an exemplary hierarchical chip design including multiple partitions. All clocks are sourced from the top level clock generation block and distributed to each partition, e.g., each RLM. There are multiple instances of several RLM types (4×TLMA, 8×RLMB, 2×RLMC). It should be appreciated that the hierarchical chip design shown in FIG. 1 is shown by way of example only, and that the timing tool described herein may be applicable to any hierarchical chip design having multiple instances of partitions.

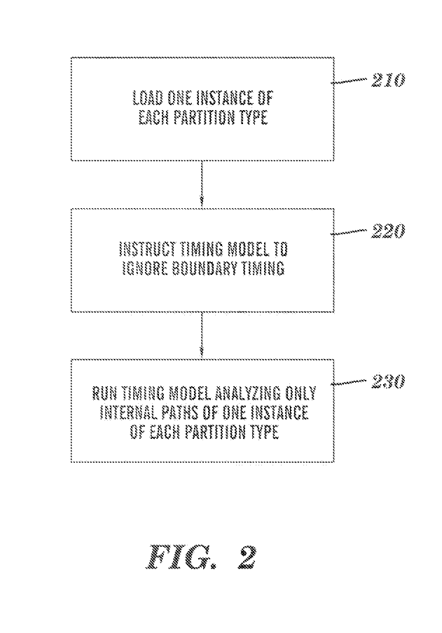

FIG. 2 illustrates a method for timing according to an exemplary embodiment. When the timing tool is reading the entire full chip netlist, the tool is directed to load only one instance of each partition type, e.g., RLM type, into the timing model at step 210, while leaving the chip top level completely intact. Before the timing run is started, the timing tool is instructed to ignore all boundary timing at step 220 by not carrying all non-clock inputs to the RLM(s). Therefore, when the timing is run at step 230, only the internal paths of one instance of each RLM type are analyzed.

Although not illustrated in the interest of brevity, it should be appreciated that any timing tool may be used to carry out the timing of the chip, using the technique as described herein. The timing tool may be implemented, e.g., with suitable software and/or logic components, depending on the needs of a user. An example of a timing tool that may be added for using the technique described herein is IBM EinsTimer™.

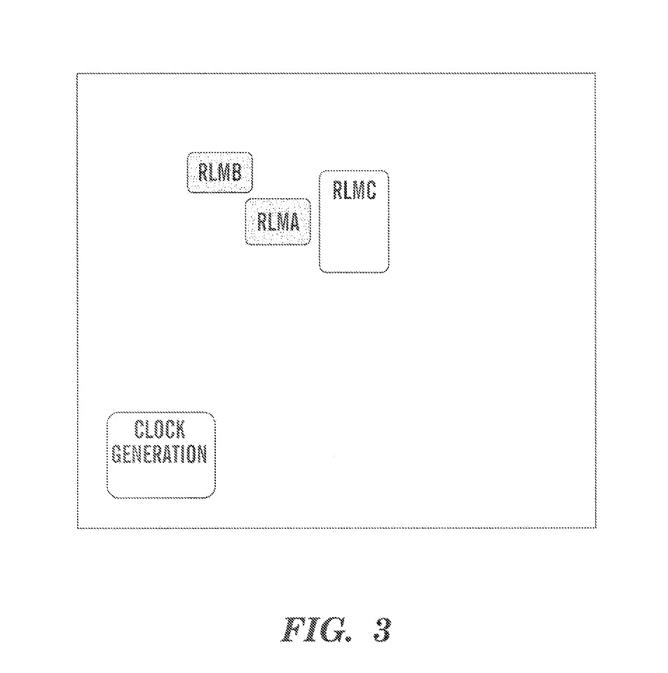

FIG. 3 illustrates a hierarchical chip design timing model, as it appears after hiding most instances according to the timing technique described herein. As can be seen from FIG. 3, the timing model is significantly smaller as compared with the diagram in FIG. 1, and can therefore run with less hardware resources. Also, the turnaround time for the timing run is significantly shorter in comparison with a timing run on all the instances of the various partitions shown in FIG. 1. Internal RLM timing information from this faster timing run is accurate, because real clocks generated from the top level are used, and all parasitic and voltage information is based on “official” full chip calculations. The time/resource savings depends on the nature of the design. As an example, in a real world experiment on a particular design, the equivalent of over 75% of the total chip paths can be timed using the technique described herein, while only performing 20% of the actual full chip timing tests.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms fist, second, etc. are used to distinguish one element from another. Furthermore, the use of the terms a, an, etc. do not denote a limitation of quantity, but rather denote the presence of at least one of the referenced item.

We claim:

1. A method for timing performance of a hierarchical chip design having multiple partition instances of at least one partition type, comprising:
loading a netlist of the chip design into a timing model, including loading a top level of the chip design and only one instance of each partition type in the chip design;
instructing the timing model to ignore boundary timing; and
running the timing model, wherein for each partition type, only the internal paths of the loaded instance are analyzed.

2. The method of claim 1, wherein the top level of the chip design is left completely intact in the timing model.

3. The method of claim 1, wherein the partition is a random logic macro (RLM).

4. The method of claim 3, wherein the partition types are different RLM types.

5. The method of claim 1, wherein the timing model takes into account actual voltage and parasitic information from the full chip design.

6. The method of claim 1, wherein the timing performance for a particular partition type is substantially identical for each instance of that partition type.

7. A computer program product for timing performance of a hierarchical chip design having multiple partition instances of at least one partition type, comprising a computer usable medium having a computer readable program, wherein the computer readable medium, when executed on a computer, causes the computer to:
load a netlist of the chip design into a timing model, wherein the top level of the chip design and only one instance of each partition type in the chip design are loaded into the timing model;
instruct the timing model to ignore boundary timing; and
run the timing model, wherein for each partition type, only the internal paths of the loaded instance are analyzed.

8. The computer program product of claim 7, wherein the top level of the chip design is left completely intact in the timing model.

9. The computer program product of claim 7, wherein the partition is a random logic macro (RLM).

10. The computer program product of claim 9, wherein the partition types are different RLMS.

11. The computer program product of claim 7, wherein the timing model takes into account actual voltage and parasitic information from the full chip design.

12. The computer program product of claim 7, wherein the timing performance for a particular partition type is substantially identical for each instance of that partition type.

13. A tool for timing performance of a hierarchical chip design having multiple partition instances of least one partition type, comprising:
a timing model; and
an input for reading a netlist of the chip design into the timing model, including a top level of the chip design and only one instance of each partition type of the chip design, and receiving instructions for the timing model to ignore boundary timing, wherein for each partition type, the timing model only analyzes the internal paths of the loaded instance.

14. The tool of claim 13, wherein the top level of the chip design if left completely intact in the timing model.

15. The tool of claim 13, wherein the partition is a random logic macro (RLM).

16. The tool of claim 15, wherein the partition types are different RLMs.

17. The tool of claim 13, wherein the timing model takes into account actual voltage and parasitic information from the full chip design.

18. The tool of claim 13, wherein the timing performance for a particular partition type is substantially identical for each partition of that type.
